(19) United States
(12) Patent Application Publication
(10) Pub. No.: US 2011/0187062 A1
(43) Pub. Date: Aug. 4, 2011

(54) COLLET SYSTEM

(75) Inventor: Richard Xu, Tomball, TX (US)

(73) Assignee: BAKER HUGHES INCORPORATED, Houston, TX (US)

(21) Appl. No.: 12/696,790

(22) Filed: Jan. 29, 2010

(51) Int. Cl. B23B 31/20

(52) U.S. Cl. 279/50

(57) ABSTRACT

A collet system having greater axial load capability and debris protection includes a sleeve and a collet. The collet is disposed in a debris protected position relative to the sleeve and is radially adjacent and axially supported by sleeve.

### BACKGROUND

In the drilling and completion industry, collets are well known structures that have been used for many varied operations in a borehole. Collets are deflective structures that may be constructed to deflect and resiliently return to original position either radially outwardly or radially inwardly. Generally, each has the same construction, which is tubular in form having cantilevered fingers created by cutting an originally tubular member axially for a distance along its axial length that is shorter than the entire axial length. Resultingly the fingers are flexible radially upon physical input. Collets are used for a great many types of holding and releasing operations.

One of the uses made of collets is as a part of a ball seat arrangement. The collet allows, in the case of a ball seat arrangement, for support fingers disposed at a longitudinal end of the collet spaced from a portion thereof that remains the full tubular form, to spread outwardly thereby reducing support for the ball previously supported thereon. While the collets do function acceptably, it is noted that debris can interfere with operation thereof. New configurations that preserve or improve traditional function of collet systems and improve reliability thereof are always well received by the art.

### SUMMARY

A collet system including a sleeve; and a collet disposed in a debris protected radially adjacent and axially supported position relative to the sleeve.

A collet system including a system housing having: a support; a recess; and a biasing member; a sleeve translationally positioned within the housing and in operable communication with the biasing member; and a collet disposed in a debris protected radially adjacent and axially supported position relative to the sleeve, and between the sleeve and the housing, the collet and sleeve being cyclable between a position where the collet is supported from radial deflection by the support and a position where the collet is axially aligned with the recess and is radially deflectable.

### BRIEF DESCRIPTION OF THE DRAWINGS

Referring now to the drawings wherein like elements are numbered alike in the several Figures:

FIG. 1 is a cross sectional view of a collet system as disclosed herein within a tubular;

FIG. 2 is a perspective cross section view of a collet portion of the collet system disclosed herein;

FIG. 3 is a perspective view of a sleeve portion of the collet system disclosed herein.

### DETAILED DESCRIPTION

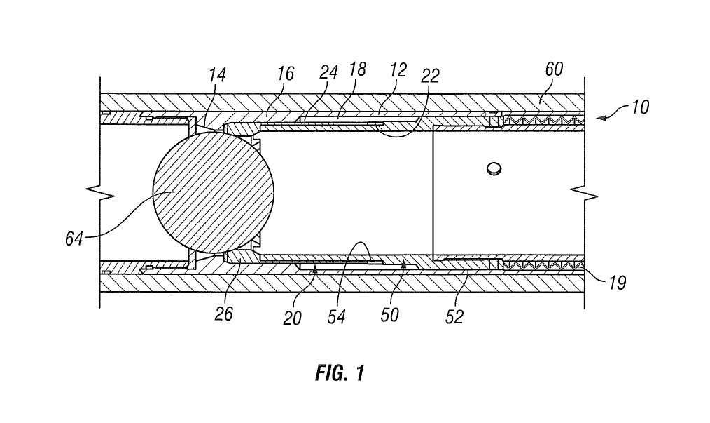

Referring to FIG. 1, Collet system 10 is outwardly bounded by a system housing 12. The housing includes a pre-seat 14 and a support 16, a recess 18 and a biasing member 19. Radially inwardly of the housing 12 is a collet 20 having a tubular root 22 and a plurality of fingers 24 that end in end features 26. Radially inwardly of the collet 20 is a sleeve 50 including a base 52 and a shoulder 54, the shoulder being interactive in a support capacity with root 22.

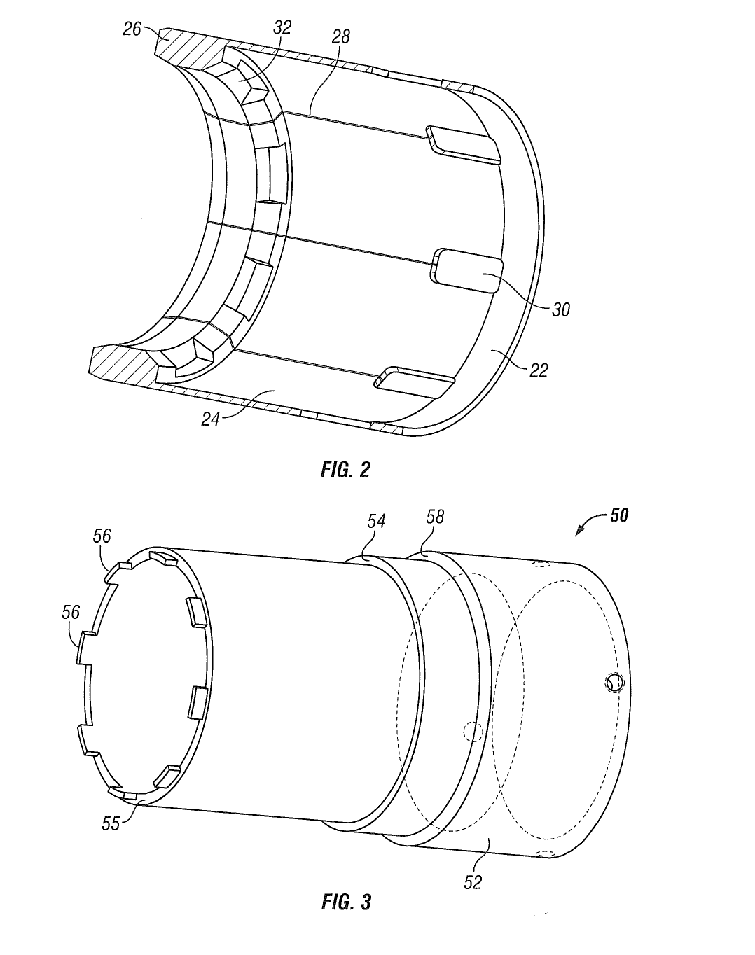

In FIGS. 2 and 3, perspective views of the collet 20 and the sleeve 50 are illustrated for a better understanding of the features thereof. Referring to FIG. 2 first, the collet 20 is illustrated. Root 22 it will be appreciated is a tubular structure that can be in some embodiments simply an unmodified portion of a tubular member from which the collet 20 is machined. The root 22 provides for structural integrity of the plurality of fingers 24 that extend therefrom, holding the plurality of fingers 24 in a tubular shape. In an embodiment, the fingers 24 are separated by a kerf or cut 28 that extends from the end features 26 to the root 22. In an alternate embodiment, one or more of the kerfs 28 may be widened at an intersection with root 22 creating openings 30 as illustrated. For embodiments employing openings 30, strain on the fingers during flexing is reduced so that flexural fatigue is reduced and longevity improved. It will be appreciated that because each finger 24 is curved, due to the fact that each is formed as a portion of a tube, there are significant stress risers at edges of the fingers in embodiments not having the openings 30. The openings 30 reduce the arc length of each finger and hence reduce the strain experienced thereby during deflection. Moreover, because the sleeve 50 is positioned so that it will support an axial load on the fingers 24, the fingers may be constructed more thinly. Thinner material of the fingers makes for easier deflection and more reliability with respect to fatigue. In prior art collet systems, the only way to support a large differential pressure across, for example a ball, would have been to make the fingers 24 thicker such that they would exhibit greater resistance to both bending axially and deflection radially. This leads to frequent fatigue related failures. The configuration disclosed herein alleviates this condition.

Further illustrated in FIG. 2 is one or more torque receptacles 32. The one or more torque receptacles 32 are each configured to receive one of the torque keys 56 of the sleeve 50 so that upon rotational input at the end features 26, the collet 20 will not rotate. In one particular situation, rotational input is occasioned by a mill or drill bit that is being used to mill or drill out the entirety of the collet system 10 for one of a number of possible purposes. If the collet 20 were to spin, the bit would not be able to cut and hence the operation to remove the collet system 10 would be at a disadvantage.

Referring directly now to FIG. 3 and the sleeve 50, the sleeve is a tubular member that is to provide structural support to and to keep debris from the collet 20. Because of the position that is taken up by the collet 20 protected from the flow of fluids that occur in this embodiment at the inside volume of the sleeve 50, very little debris such as sand can migrate through the collet 20 and hence interfere with its normal operation. This also enables the use of the openings 30 since were the sleeve 50 not in place, there would be a substantial risk of copious sand accumulating behind the collet 20 in the recess 18 thereby impeding or preventing deflection of the collet 20 into that space per the normal operation of the device. Further, collet 20 is axially supported by the sleeve 50 both at shoulder 54 and at end 55. End 55 provides direct support to end features 26 thereby substantially improving buckling resistance of the collet 20.

The one or more torque keys 56 nest with the one or more torque receptacles 32 when the collet is nested with the sleeve 50 forming a two layer tubular structure that can support axial load without buckling of the fingers 24, rotational input without spinning of the collet 20 and deflection operation of the collet 20 when in a position within the system 10 allowing for that movement.

Finally with respect to the sleeve 50, there is a neck down 58. This portion of the sleeve 50 allows for the base to closely nest with the housing 12 while facilitating the operation of the recess 18 of the housing for reception of the fingers 24 and end features 26 of the collet 20 when deflected to allow passage of a tool such as a ball.

Referring back to FIG. 1, operation of the system 10 will be appreciated. The system 10 is in one embodiment disposed within a sting of tubing 60 to be positioned in a borehole at some selected target location. The housing 12 is hence secured within the tubing 60. The housing 12 supports and locates the biasing member 19, such as a spring, that operates in a compression mode and thence will bias the sleeve 50 and collet 20 toward a position where the end features 26 are supported by support 16. The biasing member 19 will however allow, under a selected threshold pressure differential across a ball 64 having landed in the end features 26, the sleeve 50 and collet 20 to stroke in a compression direction of the spring until the end features 26 align axially with recess 18, whereupon the end features 26 will move radially into the recess 18 and as illustrated allow a ball or other device to pass. This may occur in conjunction with other systems for various purposes and the system may be used with other than a ball.

While one or more embodiments have been shown and described, modifications and substitutions may be made thereto without departing from the spirit and scope of the invention. Accordingly, it is to be understood that the present invention has been described by way of illustrations and not limitation.

1. A collet system comprising:
a sleeve; and
a collet disposed in a debris protected radially adjacent and axially supported position relative to the sleeve.

2. A collet system as claimed in claim 1 further comprising a system housing and wherein the system housing axially translationally receives the sleeve and the collet.

3. A collet system as claimed in claim 2 wherein the system housing further located a biasing member in operable communication with the sleeve and collet to bias the sleeve and collet to a selected position.

4. A collet system as claimed in claim 3 wherein the position is one in which the collet is radially supported.

5. A collet system as claimed in claim 1 wherein the collet includes a plurality of fingers adjacent ones of which are bifurcated by an opening coextensive with a kerf separating the fingers.

6. A collet system as claimed in claim 5 wherein the opening narrows an arc length of a finger adjacent a root of the collet.

7. A collet system as claimed in claim 5 wherein each kerf of the plurality of fingers includes an opening.

8. A collet system as claimed in claim 1 wherein the collet includes a plurality of end features, one or more of the plurality of end features having a torque receptacle.

9. A collet system as claimed in claim 8 wherein each of the end features includes a torque receptacle.

10. A collet system as claimed in claim 1 wherein the sleeve includes a shoulder for axially supporting the collet.

11. A collet system as claimed in claim 1 wherein the sleeve includes an end that directly supports one or more end features of the collet.

12. A collet system as claimed in claim 1 wherein the sleeve includes one or more torque keys.

13. A collet system as claimed in claim 8 wherein the sleeve includes a torque key for each torque receptacle.

14. A collet system comprising:
a system housing having:
a support;
a recess; and
a biasing member;
a sleeve translationally positioned within the housing and in operable communication with the biasing member; and
a collet disposed in a debris protected radially adjacent and axially supported position relative to the sleeve, and between the sleeve and the housing, the collet and sleeve being cyclable between a position where the collet is supported from radial deflection by the support and a position where the collet is axially aligned with the recess and is radially deflectable.

15. A collet system as claimed in claim 14 wherein the position of the collet and sleeve is dependent upon the biasing member versus input from a tool in communication with the collet.

16. A collet system as claimed in claim 14 wherein the collet is axially supported by the sleeve at a shoulder and an end thereof.

17. A collet system as claimed in claim 16 wherein the end directly supports one or more end features of the collet.
